(19) United States
(12) Patent Application Publication
(10) Pub. No.: US 2014/0152788 A1
(43) Pub. Date: Jun. 5, 2014

(54) Multi-Tablet Projector

(71) Applicant: Matteo B. Gravina, Laredo, TX (US)

(72) Inventor: Matteo B. Gravina, Laredo, TX (US)

(21) Appl. No.: 13/690,911

(22) Filed: Nov. 30, 2012

(51) Int. Cl. H04N 5/74

(52) U.S. Cl. CPC H04N 5/7475
USPC 348/63

(57) ABSTRACT

An adaptive projector to project an image from a digital device may include an adaptive socket to cooperate with the digital device, a image sensor to sense a image from the digital device and a projector screen to project the image from the digital device. The adaptive socket may be adaptable to remove and replace the digital device.

### FIELD OF THE INVENTION

The present invention relates to projectors and more particularly to a combination of an adaptive projector and a digital device.

### BACKGROUND

Image projection has always being a part of every civilization on Earth. The Mayas, and the Aztecs, as well as tribal groups in what is now Germany use light to show representations of figures. In the 20th century due to electricity, electrical projectors came into being as a communication tool. From the most commonly use in offices and schools, the projector that utilize a device that would project an image by use of light beaming between a film that contain the image and projected onto a receiving screen. Even though the old fashion projector and screen are still use, the advent of semiconductors, projected images are more commonly view through handheld devices.

Projectors nowadays come all sizes, but the usual desktop projector is still the flagship for viewing slides, film, and computer store images. The desktop projector still utilizes a strong light bulb the when pass through the image will project an image in a desirable location, presumably a screen. Even with the interconnectivity with a computerize device, it still uses the same methodology of a desktop projector connected via cables and amplifying the image onto a screen. This method of communication with the use of projections is still employ mainly in work places and education. Although using a desktop projector is still very popular is nonetheless cumbersome and time consuming this is still the most common.

Another method of projecting images onto a desirable location is the use of handheld devices that employ a strong light source. This method of projecting images is nevertheless the same methodology of employing an image, but nonetheless at a mobile employment. This method frees the user of cabling, but has a limitation because batteries run out of electrical energy at a faster rate. This method of mobile projection of images is usable more closely in professional office meetings.

Another method of projecting images is by employing the same methodology, but with the use of Light Emitting Diodes, commonly known as LED's. This method still uses the same method but because of its lower energy use than conventional projectors, its image is limited to its light source capacity to amplify the image. Even with lightweight projectors, in order to capture the image desired is by employing a screen, most of the time a large cumbersome mechanical device.

A projector screen for most of the time is a large cumbersome mechanical electronic display surface. The screen is practically the essential second part of the projector system. A screen by itself is practically a useless item. A projector for proper use requires a large screen, therefore to project an image by means of magnification.

In today's electronic mobile society, small electronic devices have become smaller, projector, and projecting devices as well. Technology has brought about numerous devices that have made their displays smaller. Devices, such as LCD Tv's, smart phones, gps, have made it almost nearly impossible for the whole of society to use these devices. For the most part, these devices are customarily use by people with good vision, therefore a limited market.
U.S. Pat. No. 7,445,339 US Patent Application 20110193334
U.S. Pat. No. 7,441,902 US Patent Application 20080111793
U.S. Pat. No. 7,215,362 US Patent Application 20050270430
U.S. Pat. No. 6,755,537 US Patent Application 20020063855
U.S. Pat. No. 6,733,138
U.S. Pat. No. 6,456,339

The above references are incorporated in their entirety.

### SUMMARY

An adaptive projector to project an image from a digital device may include an adaptive socket to cooperate with the digital device, a image sensor to sense a image from the digital device and a projector screen to project the image from the digital device;

The adaptive socket may be adaptable to remove and replace the digital device.

The digital device may be a smart phone.

The digital device may be a PDA.

The digital device may be a tablet.

The digital device may be a global positioning system GPS

### BRIEF DESCRIPTION OF THE DRAWINGS

The invention may be understood by reference to the following description taken in conjunction with the accompanying drawings, in which, like reference numerals identify like elements, and in which:

FIG. 1 illustrates a front view of a smart phone of the present invention;

FIG. 2 illustrates a front view of a personal digital assistant PDA of the present invention;

FIG. 3 illustrates a front view of a tablet computer of the present invention;

FIG. 4 illustrates a perspective view of a projector and screen;

FIG. 5 illustrates a perspective view of the adaptive projector of the present invention;

FIG. 6 illustrates a cutaway view of the adaptive projector of the present invention;

FIG. 7 illustrates an exploded view of the adaptive projector of the present invention;

FIG. 8 illustrates a cross-sectional view of the adaptive projector of the present invention;

FIG. 9 illustrates a side view of the adaptive projector of the present invention;

FIG. 10 illustrates a front view of the adaptive projector of the present invention;

FIG. 11 illustrates a another front view of the adaptive projector of the present invention;

FIG. 12 illustrates a front view of a global positioning system GPS of the present invention;

FIG. 13 illustrates a block diagram of the adaptive projector of the present invention;

### DETAILED DESCRIPTION

It is an object of the present invention to provide new and improved methods and apparatus for converting an image of a small portable device by employing an image sensor as receiver of the image of the mobile device, process it and display it onto its larger display as magnified.

Upon further study of the specification and appended claims, further objects and advantages of this invention will become apparent to those skilled in the art.

An advantage of the present invention is the use of more than one type of electrical device use for projecting an image. The advantage of being universal allows users to use an array of electrical devices making it adaptable for a plethora of uses and applications.

Furthermore an advantage of the present invention is the inside electrical device holder for electrical devices such as smart phones. By using a smart phone, it allows the user, especially older generations the ability to view clearly an image. This allows also the visual impaired to view an image or to touch a particular icon, which is difficult due to small display screen in a smart phone.

An advantage of the present invention is the inside electrical device holder for electrical devices such as a global positioning system unit. By allowing, the user to amplify an image the user can amplify an image further allowing the user better grasp of moving content.

An advantage of the present invention is the inside electrical device holder for electrical devices such as personal digital assistant. By allowing the user to amplify an image, the user can better explain details when trying to communicate a message.

An advantage of the present invention is the inside electrical device holder for electrical devices such as tablet computer. When using a table computer, the user can amplify an image for increase audience participation. This allows a wider audience to view an intended image.

An advantage of the present invention is the ability to use more than one type, and more than one kind of electrical devices, such as smart phones. The present invention allows for an array of smart phones as long the screen is accessible.

An advantage of the present invention is the inside electrical device holder for electrical devices frees the user from using a large screen for the projection. This alleviates the user from carrying large cumbersome screens.

An advantage of the present invention is the inside electrical device holder for electrical devices which a conventional projector does not allow. Media content of an array of electrical devices permits the user to use multiple electrical devices, unlike the conventional projector only permits either one or two devices to interconnect media.

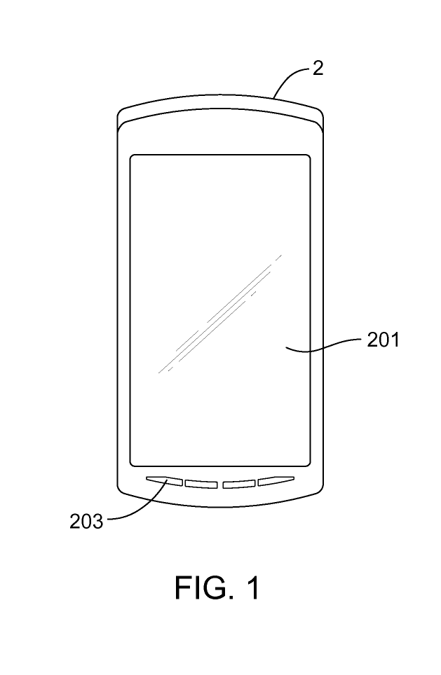

FIG. 1 illustrates a front view of the smart phone 2 of the present invention which may include a smart phone display to display images from the smart phone and may include smart phone controls 203 to control the operation of the smart phone 2.

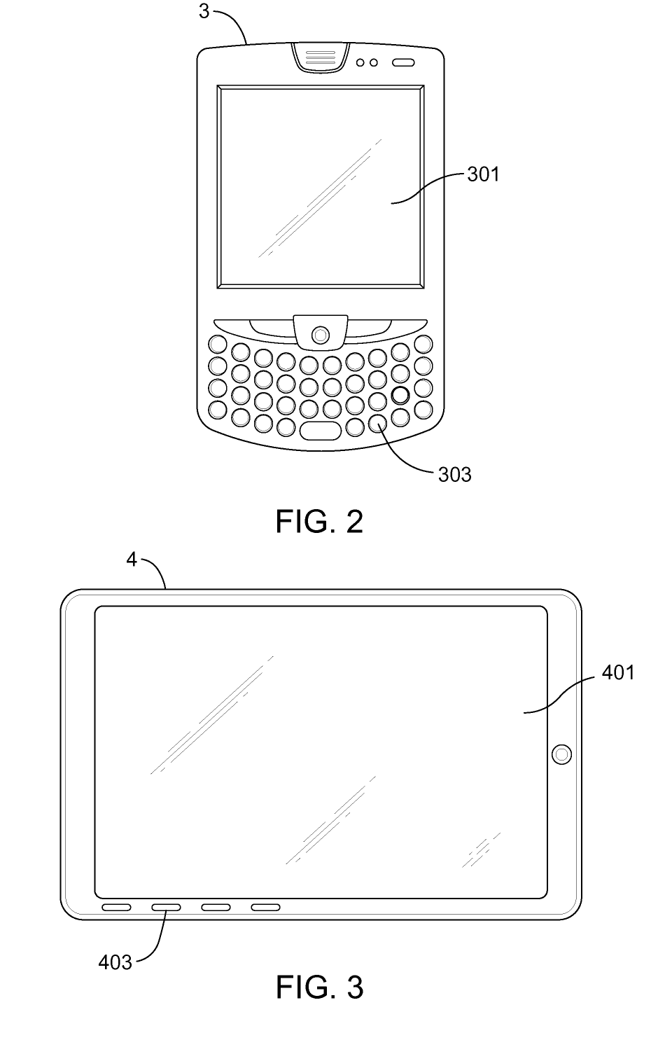

FIG. 2 illustrates a front view of a PDA computer 3 which may include a PDA computer display to display information and images from the PDA computer 3 and may include PDA computer controls 303 to control the PDA computer 3.

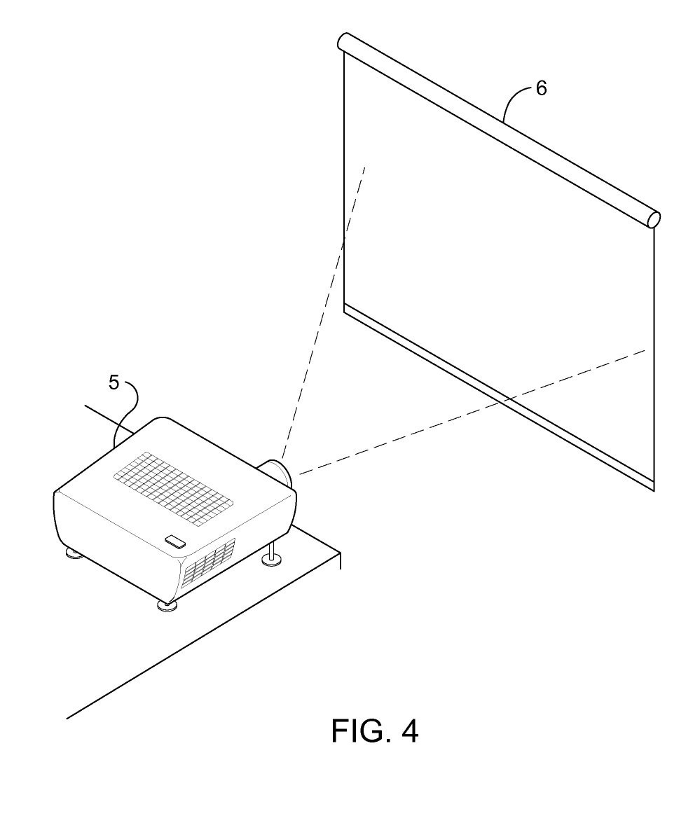

FIG. 4 illustrates a front view of a tablet computer 4 which may include a tablet computer display 401 to display information and images from the tablet computer for and may include tablet computer controls 403 to control the tablet computer 4.

FIG. 4 illustrates a perspective view of a projector 5 which may project an image onto a screen 6 and which may be a handheld projector 5.

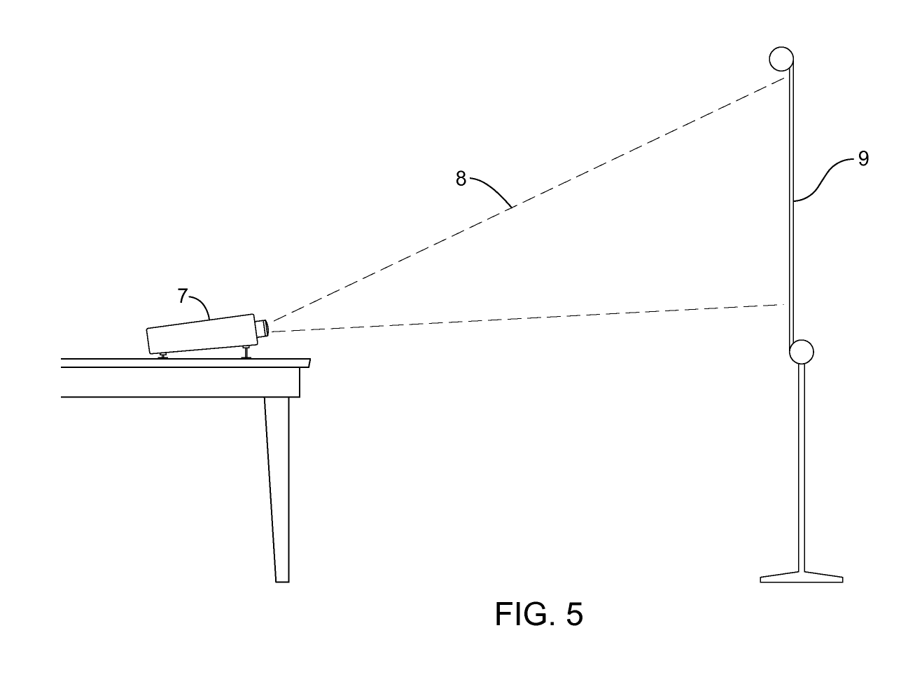

FIG. 5 illustrates a perspective view of a handheld projector 7 to project an image 8 from the handheld projector 7 to the substantially vertical screen 9.

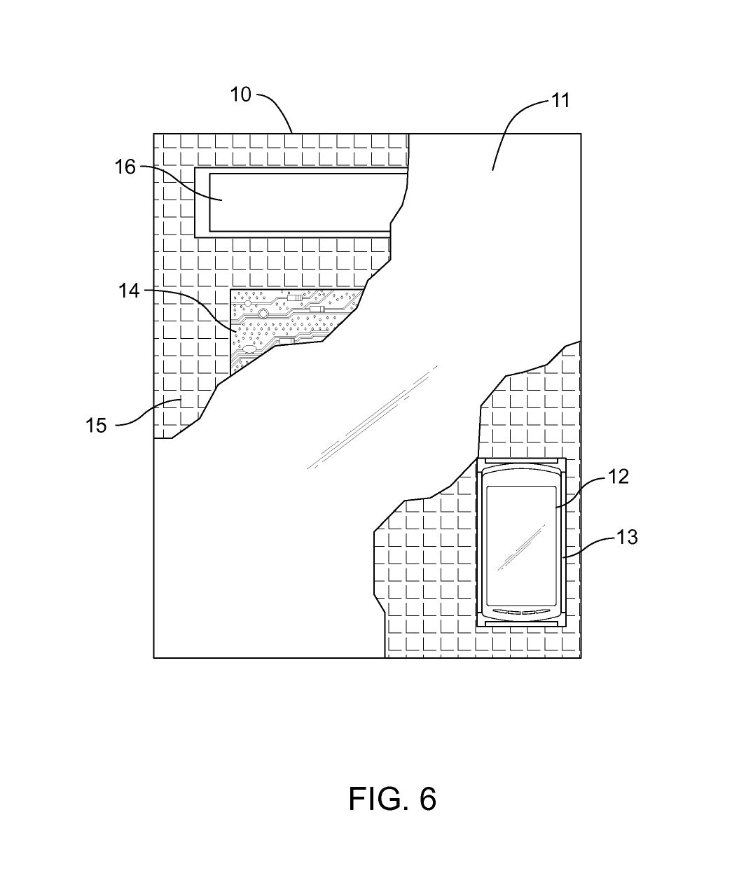

FIG. 6 illustrates a view of the adaptive projector 10 of the present invention and illustrates a projector screen 11 which may substantially cover the front of the adaptive projector 10 to display images and information from the adaptive projector 10. The adaptive projector 10 of the present invention may include a digital device 12 which may be a smart phone 2, a PDA 3, and a tablet computer 4 or another digital device 12.

The digital device 12 may be positioned within an adaptive socket 13 which may be a hollow area within the adaptive projector 10.

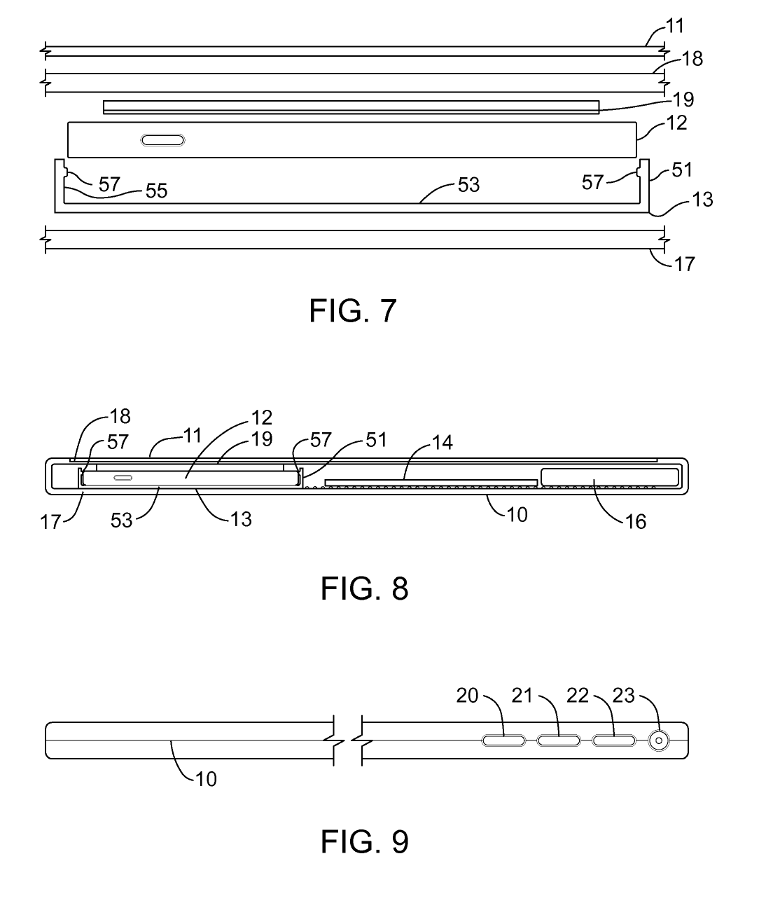

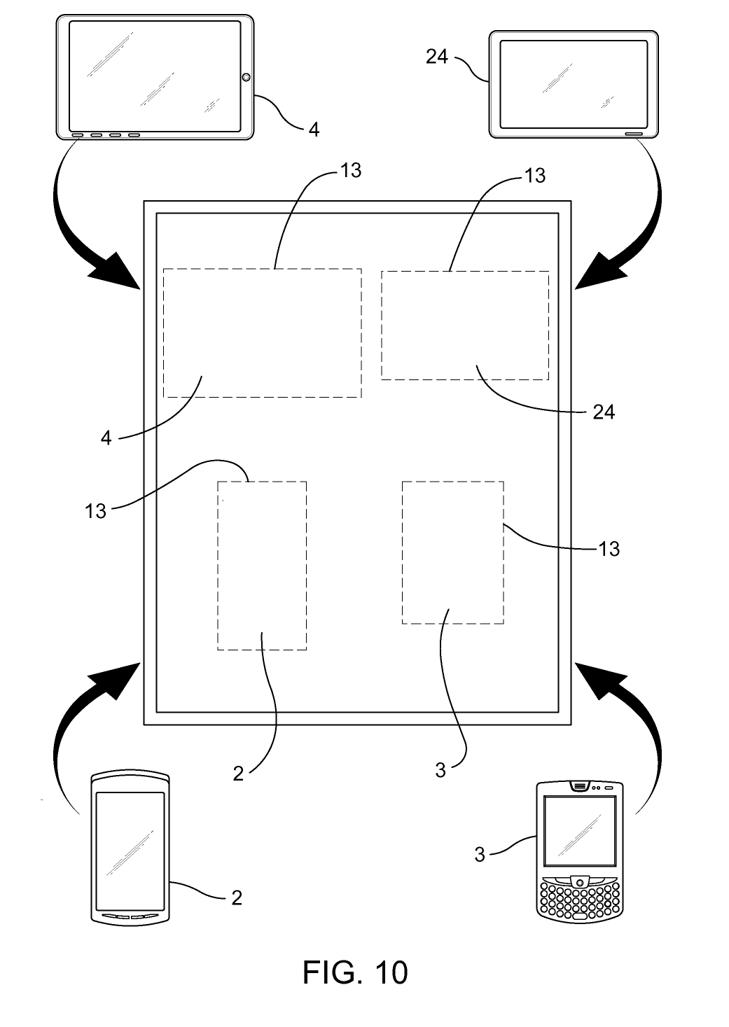

FIG. 7 illustrates the adaptive socket 13 which may include a substantial U-shaped housing 51 which may include a base member 53, a pair of opposing side members 55 which may be connected to the base member 53 and a pair of opposing inward extending arms 57 which may be connected to the side members 55 to retain the digital device 12 within the housing 12. The side members 55 may be sufficiently flexible to allow the digital device 12 to be nondestructively detachably connected to the housing 12 so that the digital device 12 can be removed and replaced with another digital device 12.

FIG. 7 additionally illustrates that the adaptive projector 10 includes a adaptive screen transceiver 19 to cooperate with the screen of the digital device 12 to transfer images from the screen of the digital device 12 to be projected by the adaptive projector 10 and includes a upper frame member 18 which may be connected to the transceiver 19 to hold the transceiver 19 in position. The upper frame member 18 may be hinged or may be detachably connected to the adaptive projector 10 to facilitate the removal of the digital device 12.

FIG. 8 illustrates a side view of the adaptive projector 10 and illustrates a battery 16, a controller 14 which may be a microprocessor and the adaptive socket 13 which may be in substantially the same plane as the battery 16 and controller 14.

FIG. 8 illustrates the adaptive socket 13 which may include a substantial U-shaped housing 51 which may include a base member 53, a pair of opposing side members 55 which may be connected to the base member 53 and a pair of opposing inward extending arms 57 which may be connected to the side members 55 to retain the digital device 12 within the housing 12. The side members 55 may be sufficiently flexible to allow the digital device 12 to be nondestructively detachably connected to the housing 12 so that the digital device 12 can be removed and replaced with another digital device 12.

FIG. 8 additionally illustrates that the adaptive projector 10 includes a adaptive screen transceiver 19 to cooperate with the screen of the digital device 12 to transfer images from the screen of the digital device 12 to be projected by the adaptive projector 10 and includes a upper frame member 18 which may be connected to the transceiver 19 to hold the transceiver 19 in position. The upper frame member 18 may be hinged or may be detachably connected to the adaptive projector 10 to facilitate the removal of the digital device 12.

FIG. 9 illustrates a side view of the adaptive projector 10 which may include a screen luminosity button 20 to control the luminosity of the screen of the screen transceiver 19, contrast button 21 to control the contrast of the screen of the screen transceiver 19, a power button 22 to control the power setting of the adaptive projector 10 and a AC plug-in port 23 to allow power to be input to the adaptive projector 10.

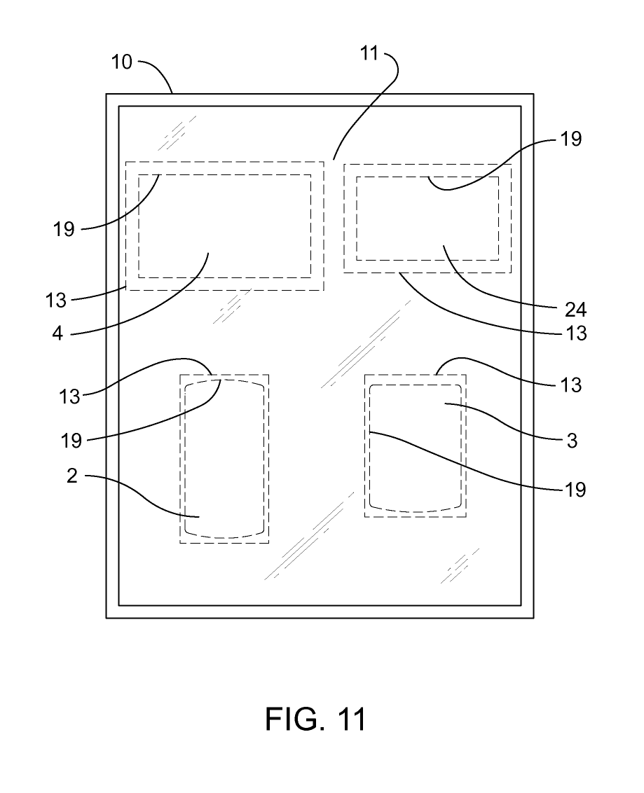

FIG. 11 illustrates that a tablet computer 4, the smart phone 2, the PDA 3 and a global positioning system GPS 24 may be simultaneously positioned within the adaptive projector 10 and each of the tablet computer 4, the smart phone 2, the PDA 3 and the global positioning system 24 may be positioned in a respective socket 13 within the adaptive projector 10.

FIG. 11 illustrates that a tablet computer 4, the smart phone 2, the PDA 3 and a global positioning system GPS 24 may be simultaneously positioned within the adaptive projector 10 and each of the tablet computer 4, the smart phone 2, the PDA 3 and the global positioning system 24 may be positioned in a respective socket 13 within the adaptive projector 10. Additionally, FIG. 11 illustrates the first transceiver 19 which is positioned over the screen of the tablet 4, the second transceiver 19 which is positioned over the screen of the GPS device 24, the third transceiver 19 which is positioned over the screen of the smart phone 2 and the fourth transceiver 19 which is positioned over the PDA 3, and FIG. 11 illustrates the screen 11 of the adaptive projector 10 which may extend over the screen of the tablet 4, extend over the screen of the GPS 24, may extend over the screen of the smart phone 2 and may extend over the screen of the PDA 3.

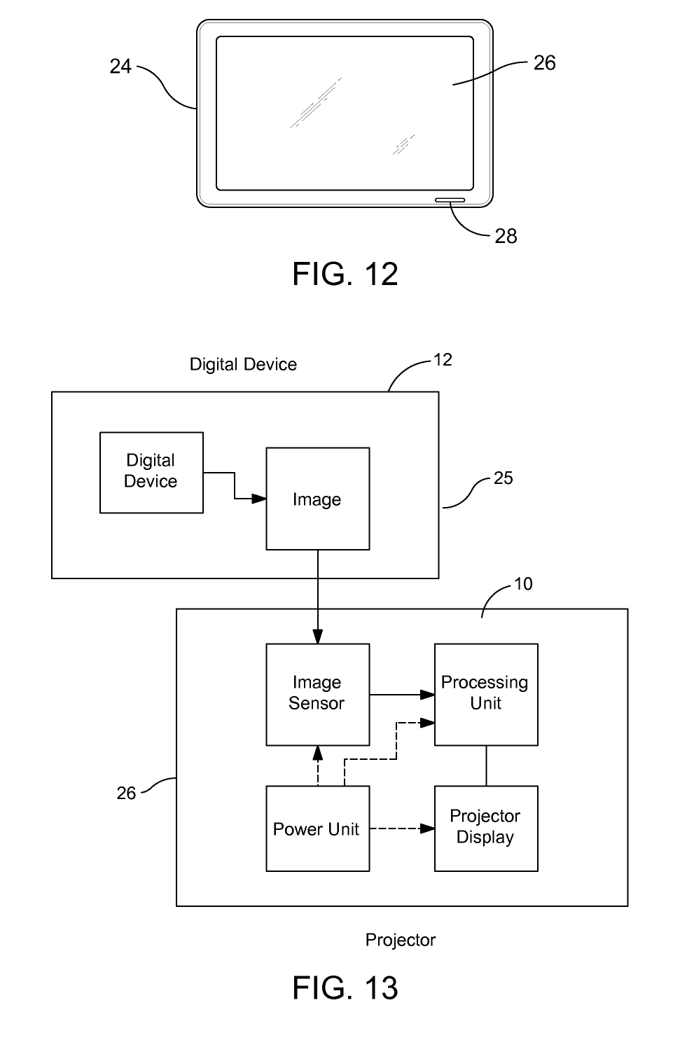

FIG. 12 illustrates a front view of the GPS 24 which may include a GPS screen 26 and GPS controls 28.

FIG. 13 illustrates a circuit diagram of the digital device 12 and the projector 10

While the invention is susceptible to various modifications and alternative forms, specific embodiments thereof have been shown by way of example in the drawings and are herein described in detail. It should be understood, however, that the description herein of specific embodiments is not intended to limit the invention to the particular forms disclosed.

1) An adaptive projector to project an image from a digital device, comprising:
an adaptive socket to cooperate with the digital device;
a image sensor to sense a image from the digital device;
a projector screen to project the image from the digital device;
wherein the adaptive socket is adaptable to remove and replace the digital device.

2) An adaptive projector to project an image from a digital device as in claim 1, wherein the digital device is a smart phone.

3) An adaptive projector to project an image from a digital device as in claim 1, wherein the digital device is a PDA.

4) An adaptive projector to project an image from a digital device as in claim 1, wherein the digital device is a tablet.

5) An adaptive projector to project an image from a digital device as in claim 1, wherein the digital device is a global positioning system GPS
